(19) United States
(12) Patent Application Publication
(10) Pub. No.: US 2012/0253792 A1
(43) Pub. Date: Oct. 4, 2012

(54) Sentiment Classification Based on Supervised Latent N-Gram Analysis

(75) Inventors: Dmitriy Bespalov, Philadelphia, PA (US); Bing Bai, Princeton Junction, NJ (US); Yanjun Qi, Princeton, NJ (US)

(73) Assignee: NEC LABORATORIES AMERICA, INC., Princeton, NJ (US)

(21) Appl. No.: 13/424,900

(22) Filed: Mar. 20, 2012

Related U.S. Application Data
(60) Provisional application No. 61/469,297, filed on Mar. 30, 2011.

(51) Int. Cl. G06F 17/27

(52) U.S. Cl. 704/9

(57) ABSTRACT

A method for sentiment classification of a text document using high-order n-grams utilizes a multilevel embedding strategy to project n-grams into a low-dimensional latent semantic space where the projection parameters are trained in a supervised fashion together with the sentiment classification task. Using, for example, a deep convolutional neural network, the semantic embedding of n-grams, the bag-of-occurrence representation of text from n-grams, and the classification function from each review to the sentiment class are learned jointly in one unified discriminative framework.

### RELATED APPLICATIONS

This application claims the benefit of U.S. Provisional Application No. 61/469,297, filed Mar. 30, 2011, the entire disclosure of which is incorporated herein by reference.

### FIELD

The present disclosure relates to methods for identifying and extracting subjective information from natural language text. More particularly, the present disclosure relates to a method and system for sentiment classifying text using n-gram analysis.

### BACKGROUND

Sentiment analysis (SA) or polarity mining involves the tasks of identifying and extracting subjective information from natural language text. Automatic sentiment analysis has received significant attention in recent years, largely due to the explosion of social oriented content online (e.g., user reviews, blogs, etc). As one of the basic SA tasks, sentiment classification targets to classify the polarity of a given text accurately towards a label or a score, which indicates whether the expressed opinion in the text is positive, negative, or neutral.

Prior art sentiment classification methods classify the polarity of a given text at either the word, sentence (or paragraph), or document level. Some methods relate the polarity of an article to sentiment orientation of the words in the article. Latent semantic analysis has been used to calculate the semantic orientation of the extracted words according to their co-occurrences with the seed words, such as excellent and poor. The polarity of an article is then determined by averaging the sentimental orientation of words in the article.

Instead of limiting the analysis on the word level, other prior art methods perform sentiment classification on the article level. Various methods have been proposed and they mainly differ in the features used where most methods focus on using unigrams and/or filtered bigrams only. Also, inverse document frequency (IDF) weighting schemes have been used as features and found to improve the sentiment classification accuracy effectively.

Still other methods capture substructures existing in the article in order to help polarity prediction. For example, some methods use an hidden Markov-based model to describe the dependency between local content substructures in text in order to improve sentiment polarity prediction. Similarly, other methods learn a different content model (aspect-sentiment model) using large-scale data sets in an unsupervised fashion.

Accordingly, an improved method for sentiment classifying text is needed.

### SUMMARY

Disclosed herein is a method for determining the sentiment of a text document. The method may comprise embedding each word of the document into feature space in a computer process to form word embedding vectors; linking the word embedding vectors into an n-gram in a computer process to generate a vector; mapping the vector into latent space in a computer process to generate a plurality of n-gram vectors; generating a document embedding vector in a computer process using the n-gram vectors; and classifying the document embedding vector in a computer process to determine the sentiment of the document.

### BRIEF DESCRIPTION OF THE DRAWINGS

FIG. 1 is a high level flowchart of a method for sentiment classifying according to an embodiment of the present disclosure.

FIG. 2 is a flow chart of the phrase or n-gram embedding process of FIG. 1, according to an exemplary embodiment of the present disclosure.

FIG. 3 is a block diagram of an exemplary embodiment of a computer system or apparatus that may be used for executing the methods described herein.

### DETAILED DESCRIPTION

The method of the present disclosure classifies the sentiment orientation of text at the article level using high order n-grams (i.e., short phrases of 3 or more words), because intuitively longer phrases tend to be less ambiguous in terms of their polarity. An n-gram is a sequence of neighboring n items from a string of text or speech, such as syllables, letters, words and the like.

The method of the present disclosure uses high order n-grams for capturing sentiments in text. For example, the term “good” commonly appears in positive reviews, but “not good” or “not very good” are less likely to appear in positive comments. If a bag-of-unigrams (bag of all possible words) model is used, and the term “not” is separated from the term “good”, the term “not” does not have the ability to describe the “not good” combination. Similarly, if a bag-of-bigrams model is used, the model can not represent the short pattern “not very good.” In another example, if a product review uses the phrase “Terrible, Terrible, Terrible,” the review contains a more negative opinion than three separate occurrences of “Terrible” in the review.

Building n-gram features (words) can remedy the above-identified issue, however, it is computationally very difficult to model n-gram (for n>=3) raw features directly. This is due to the extremely large parameter space associated with n-grams. For instance, assuming the English word dictionary size as D, then bigram representation of text relates to D² free parameters, while trigram relates to D³ free parameters. When the number of training samples is limited, it can easily lead to over fitting. If the unigram dictionary has a size D=10,000, we have D=10⁸ free parameters or D³=10¹² that need to be estimated, which is far too many for a small corpora (bodies of writing). As more and more web-scale sentiment data sets become available, large corpora with sentiment labels could be accessible easily for researchers.

To solve the excessively high-dimensional problem, the method of the present disclosure represents each n-gram as a embedding vector, hereinafter referred to as a “latent n-gram.” A multi-level embedding strategy may be used to project n-grams into a low-dimensional latent semantic space where the projection parameters are trained in a supervised fashion together with the sentiment classification task. Using, for example, a deep convolutional neural network, the semantic embedding of the n-grams, the bag-of-occurrence representation of text from n-grams, and the classification function from each review to the sentiment class, are learned jointly in one unified discriminative framework. The method of the present disclosure advantageously utilizes an embedding space to greatly reduce the dimensionality of the n-gram, therefore, making it much easier to model than n-gram raw features. Further, the n-gram embeddings are learned using supervised signals with the main sentiment classification task, therefore, the n-gram embeddings are optimized for the task and require little human input in feature engineering.

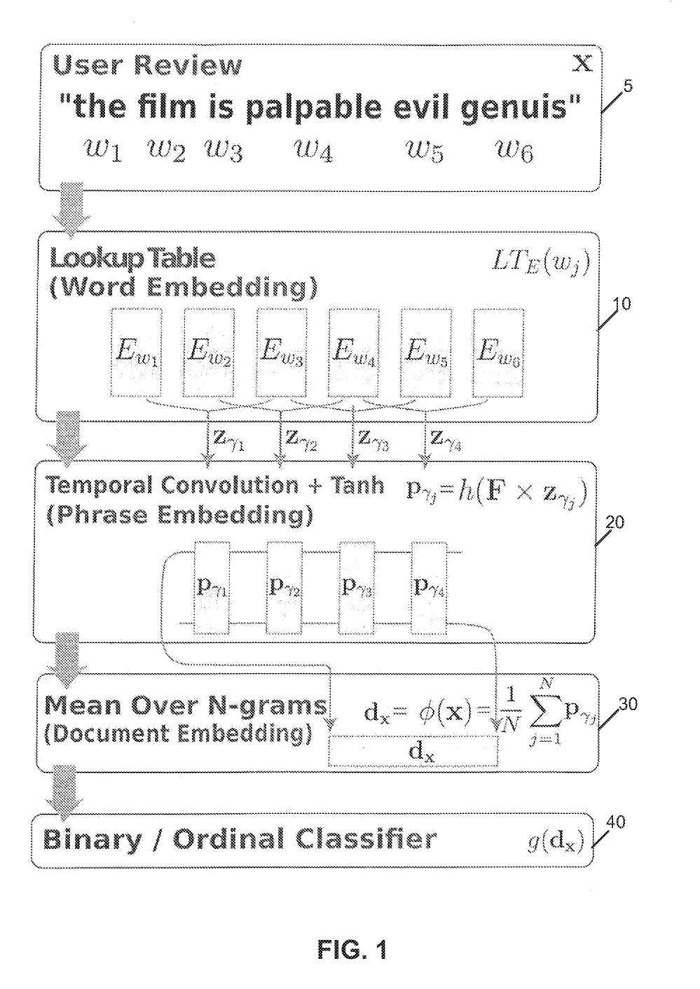

FIG. 1 is a high level flowchart of a method for sentiment classifying according to an embodiment of the present disclosure. In block 5, one or more strings of text of a document of interest (user review) is provided for sentiment classifying. In block 10, a word embedding process may be performed on one or more strings of text of the document of interest. The word embedding process may comprise identifying each word by its index i in dictionary D. The words in D may be sorted by their document frequency (DF) in a training corpus. An embedding vector of dimension i may be assigned to each word (i-th word) of the text as eᵢ=[eᵢ¹eᵢ², . . . eᵢ^{m}]^{T}, using for example, a lookup table. Each element eᵢ of the embedding vector may be a real number. The element of this vector may be learned by back-propagation through the training on the task of interest.

In some embodiments, the element of the embedding vector may be initialized by an unsupervised method such as, but not limited to, latent semantic indexing. Each element eⱼⁱε [symbol] ,jε[1 . . . m], in the context of latent semantic indexing, represents the [symbol] component of concept j in the word i-th. Given a sentence of n words, this sentence may be represented by a sequence of n word (w) embedding vectors

s=(ew₁, e_{w2}, . . . e_{wn}).

In block 20, the embedding vectors generated in block 10 are used in a phrase or n-gram embedding process, to generate phrase or n-gram vectors. The term “phrase” in the present disclosure refers to a sliding window of length k in a sentence of the text. For example but not limitation, if k==3, phrase 1 can be (w₁, w₂, w₃) and phrase 2 can be (w₂, w₃, w₄), etc. The maximum index of the phrases would be n−k+1. If the sentence is not long enough to make (n<k), artificial words can be appended as “padding” to make up the shortage. Phrase embedding vector pᵢ of the i-th phrase may be, pᵢ=h(F·cᵢ). Concatenation vector cᵢε [symbol] ^{km} is the concatenation of word embeddings of words in i-th phrase: C_{i=[e}_{wi}¹, e_{wi}², . . . e_{wi}^{m}, e_{wi+1}¹, e_{wi+k-1}^{m}_{,]}^{T}, and Fε [symbol] ^{b×km} is an embedding matrix. Each row in F can be viewed as a “loading vector” on which a concatenation vector can be projected to generate the component. This behavior is similar to other dimension reduction methods like PCA and LSI. The difference is that the loading vectors of the present disclosure are generated by semi-supervised training. The nonlinear function h(x)ᵢ=tan h(xᵢ) is an element-wise operator on phrase embedding vector pᵢ. This nonlinear function converts an unlimited output range to [−1, 1].

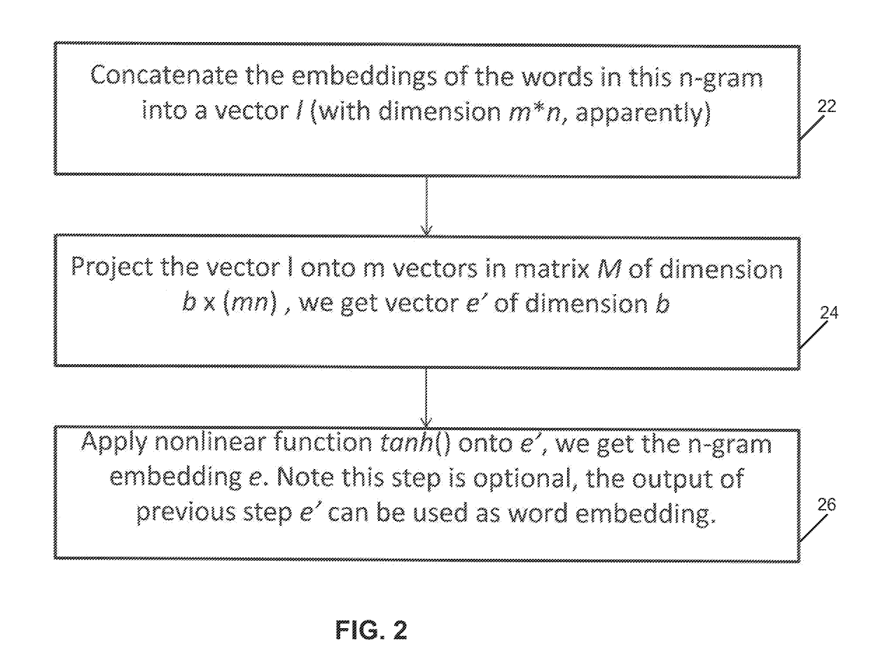

FIG. 2 is a flow chart of the phrase or n-gram embedding process of FIG. 1, according to an exemplary embodiment of the present disclosure. In block 22, word embedding vectors (generated in block 10) in each n-gram are concatenated into a vector pi. The vector pi may have an apparent dimension m*n. In block 24, the vector pi may be projected onto m vectors in matrix M of dimension b×(mn), which produces vector e′ of dimension b. In some embodiments, a nonlinear function tan h may be applied to the vector e′ to produce an n-gram embedding vector, as in block 26.

Referring again to FIG. 1, in block 30, a document embedding process may be performed using the phrase or n-gram embedding vectors generated in block 20, to generate a document embedding vector for each document. The document embedding vector may comprise a length b, and a k-th element that may be the mean value of the k-th element of all the n-gram embedding vectors in the document, generated by a sliding window of with n. More specifically, the document embedding process may be defined as

$$d = \frac{1}{N - n + 1} {\sum }_{j = 1}^{N - n + 1} {p}_{j} .$$

Here, dε [symbol] ^{b} is a b-dimension embedding. P is the matrix with all the phrase embedding in it's columns, P=[p₁|p₂| . . . |p_{N-n+1}], N is the length of the document.

In other words, the i-th element in document embedding d is the mean value of i-th dimension of all phrase embeddings. The rational behind this is that the sentiment of a document is related to the average polarity of all phrases. The more positive phrases in the document, the more likely the document is of a positive opinion. Mean value is a good summarization for the sentiment of the document.

Another fundamental reason for this formulation is that the number of phrases in the sentence is variable depending on the sentence length n. Thus, we need a function to compress the information from these phrases into a fixed length document embedding vector. There are of course many options for this operation. For example, in some embodiments, a max function, which selects the maximum value in each phrase embedding dimension outputs a fixed dimension vector may be used for this operation instead of the mean function described earlier.

Referring still to FIG. 1, the method flows to block 40 where the document embedding vector generated in block 30 is used as input to a classifier, which processes the input and predicts the sentiment of the document. In some embodiments, the classifier may comprise binary classifier, which performs a binary classification scheme that classifies the document as positive or negative. Specifically, given the document embedding vector d defined above, classification loss: L(D)=Σ_{dεD}(c(d)−yd) where c(d)ε{1,−1} are the prediction of the classifier, and ydε{1,−1} is the label of document. A class c is searched for in the class set C such that:

ĉ=arg min_{cεc}Σ_{dεD}(c(d)−yd).

Then, a linear classifier c(x)=sgn(Wx+b) can be selected to optimize classification performance.

In other embodiments, the classifier may comprise an ordinal classifier, which performs an ordinal regression scheme that ranks the document, for example but not limitation, on a likert-scale such that the class labels are in rank order. Utilizing ordinal information in the classification may achieve better performance than treating each class separately. There are different methods for ordinal classification/regression. In some embodiments, the ordinal classification scheme may comprise a simple marginal ordinal loss:

$$L ( D ) = {\sum }_{d ∈ D} \{ {\sum }_{1 \leq l \leq yd} max ( 0 , 1 - f ( d ) + {B}_{l} ) + {\sum }_{yd < l \leq t}^{ } max ( 0 , 1 - {B}_{l} + f ( d ) ) \}$$

In this embodiment, a t-likert-scale system is disclosed where a set of boundaries B₁ is provided for each class lε[1, t]. These boundaries may be in ascending orders, i.e. Bᵢ<Bⱼ, ∀ᵢ<j. The function ƒ(d) outputs a score for a document embedding vector d. The objective is to find the parameters (function θ(•) and class boundaries Bᵢ, iε[1, t]) that minimizes L(D). The classifier c(d) may be defined as:

$$c ( d ) = arg {min}_{l ∈ [ 1 , t ]} ( {B}_{l - 1} < f ( d ) < {B}_{l} )$$

The method of the present disclosure can be implemented using a layered network structure, such as but not limited to a convolutional neural network. In one exemplary embodiment, the neural network may comprise a 5-layer architecture including a lookup table layer (first level) for word embedding, a temporal convolution layer (second level) for phrase embedding, a transfer tan h layer (third level) for phrase embedding, a mean function layer for document embedding, and a classifier layer (e.g., binary, ordinal, etc.) for classifying the sentiment of the document. The use of a neural network allows for easy training using back propagation. The stacked layers in the neural network can be written in a form of embedded functions:

y=ƒₙ(ƒₙ₋₁( . . . (ƒ₁(x)) . . . )).

For a layer ƒᵢ, iε[1, n], the derivative for updating its parameter set θᵢ is:

$$\frac{\partial y}{\partial {θ}_{i}} = \frac{\partial {f}_{n}}{\partial {f}_{i}} \frac{\partial {f}_{i}}{\partial {θ}_{i}} ,$$

and the first factor on the right can be recursively calculated:

$$\frac{\partial {f}_{n}}{\partial {f}_{i}} = \frac{\partial {f}_{n}}{\partial {f}_{i + 1}} \frac{\partial {f}_{i + 1}}{\partial {f}_{i}} .$$

Further more, a stochastic gradient descent (SGD) method may be used to accelerate training of the network. For a set of training samples, instead of calculating true gradient of the objective on all training samples, SGD calculates gradient and updates accordingly on each training sample. SGD has proven to be more scalable and more efficient than the batch-mode gradient descent method. In one embodiment, the training algorithm may be defined as:

```
for j = 1 to MaxIter do
  if converge then
    break
  end if
  x, y ← random sampled data point and label
  calculate loss L(x; y)
  cumulative ← 1
  for i = 5 to 1 do
  $\frac{\partial L}{\partial {θ}_{i}} ← cumulative * \frac{\partial {f}_{i}}{\partial {θ}_{i}}$
  ${θ}_{i} ← {θ}_{i} - λ \frac{\partial L}{\partial {θ}_{i}}$
  $cumulative ← cumulative * \frac{\partial {f}_{i + 1}}{\partial {f}_{i}}$
  end for
end for
```

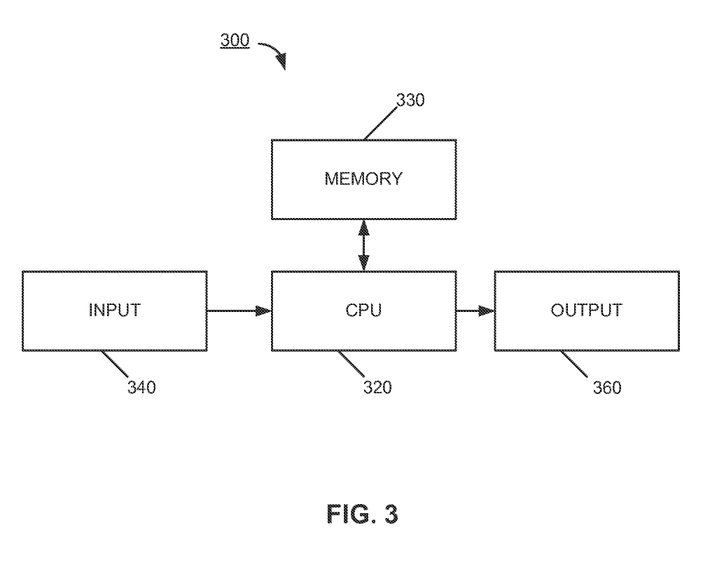

FIG. 3 is a block diagram of an exemplary embodiment of a computer system or apparatus 300 that may be used for executing the methods described herein. The computer system 300 may include at least one CPU 320, at least one memory 330 for storing one or more programs which are executable by the CPU 320 for performing the methods described herein, one or more inputs 340 for receiving input data and an output 360 for outputting data.

While exemplary drawings and specific embodiments of the present disclosure have been described and illustrated, it is to be understood that that the scope of the invention as set forth in the claims is not to be limited to the particular embodiments discussed. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

What is claimed is:

1. A method for determining the sentiment of a text document, the method comprising the steps of:
embedding each word of the document into feature space in a computer process to form word embedding vectors;
linking the word embedding vectors into an n-gram in a computer process to generate a vector;
mapping the vector into latent space in a computer process to generate a plurality of n-gram vectors;
generating a document embedding vector in a computer process using the n-gram vectors; and
classifying the document embedding vector in a computer process to determine the sentiment of the document.

2. The method of claim 1, wherein the linking step is performed through a sliding window of a predetermined length.

3. The method of claim 1, wherein the mapping step comprises projecting the vector onto vectors in a matrix.

4. The method of claim 1, further comprising the step of limiting an output range of the n-gram vectors prior to the generating step.

5. The method of claim 4, wherein the limiting step is performed with a nonlinear function.

6. The method of claim 4, wherein the limiting step is performed with a tan h function.

7. The method of claim 1, wherein the classifying step is performed with a binary classifier.

8. The method of claim 1, wherein the classifying step is performed with a ordinal classifier.

9. The method of claim 1, wherein at least one of the embedding, linking, mapping, generating and classifying steps are performed with a layered network.

10. The method of claim 9, wherein the layered network comprises a neural network.

11. The method of claim 9, further comprising the step of training the layered network with a set of training samples.

12. The method of claim 11, wherein the training step is performed by back-propagation.

13. The method of claim 12, wherein the back-propagation comprises stochastic gradient descent.
